(19) United States
(12) Patent Application Publication
(10) Pub. No.: US 2008/0211962 A1
(43) Pub. Date: Sep. 4, 2008

(54) FRAME SYNCHRONIZER CIRCUIT

(76) Inventors: Hisaji Murata, Osaka (JP); Toshihiro Miyoshi, Osaka (JP); Nariaki Yamamoto, Hyogo (JP)

Correspondence Address: WENDEROTH, LIND & PONACK L.L.P., 2033 K. STREET, NW, SUITE 800, WASHINGTON, DC, 20006, US

(21) Appl. No.: 11/960,108

(22) Filed: Dec. 19, 2007

(30) Foreign Application Priority Data
Dec. 19, 2006 (JP) 2006-340625

(51) Int. Cl. H04N 5/04

(52) U.S. Cl. 348/500; 348/E05.009

(57) ABSTRACT

When it is detected that a write address signal and a read address signal coincide with each other during in the judgment range state, an address value of the write address signal is held to halt writing into a memory, whereby a video signal is outputted without mixing old and new frames therein. Therefore, a buffer area in the memory can be minimized, and an address control circuit can be appropriately controlled even when the frame frequency difference exceed a buffer capacity, thereby a frame synchronizer circuit that can output normal pictures is provided.

### FIELD OF THE INVENTION

The present invention relates to a frame synchronizer for converting a video signal including a signal below standard (hereinafter referred to as “nonstandard signal”) into a stable standard signal, in a video signal processing apparatus such as a VTR or a DVD recorder.

### BACKGROUND OF THE INVENTION

In a DVD recorder, a video signal supplied from a tuner or an external terminal is compressed according to the MPEG2 standard or the like and recorded. At this time, a frame synchronizer circuit is used for converting a VTR playback signal or a fast-forward/rewind playback signal, i.e., a so-called nonstandard signal, which is included in the inputted video signal, into a standard signal based on the standard. The nonstandard signal is a signal whose frame frequency deviates from the standard due to an increase or decrease in the number of lines within one frame.

Generally, the frame synchronizer circuit has a memory in which data corresponding to one or more frames can be stored, and performs writing of a video signal into the memory synchronized with a write clock, and performs reading of the video signal from the memory synchronized with a read clock. However, since a write address to the memory that is generated synchronized with the write clock is not synchronized with a read address from the memory that is generated synchronized with the read clock, if either of the addresses overtakes the other address, the data in the current frame and the data in the previous frame are replaced to generate a frame including old and new frames mixed, thereby resulting in that the output data are temporarily discontinuous. Especially, when the output video is a moving image, there are discontinuous images displayed on the screen. In order to avoid such phenomenon, there has been proposed a method of perform outputting by outputting the same frame twice (holding) or outputting frames with skipping one frame (skipping) so as to maintain continuity in the output data. This outputting processing with holding or skipping frames is carried out on the basis of the clock frequency difference between the write clock and the read clock, or the frame frequency difference between the input signal and the output signal.

Further, though an oriented use memory has been conventionally used for each function, unification of memories has been progressed in recent years, which shares a memory for performing plural functions. This requires minimizing the capacity of a memory as much as possible.

FIG. 6 is a block diagram illustrating a construction of a conventional frame synchronizer circuit.

The frame synchronizer circuit shown in FIG. 6 includes a memory 1, a write address counter 2, a read address counter 3, a synchronization separation circuit 4, an address comparison circuit 5, a judgment circuit 6, and an address control circuit 7.

The memory 1 has a memory area for one frame, i.e., a frame memory area, and a buffer area having a predetermined capacity.

The write address counter 2 generates a write address signal for writing the input video signal S1 into the memory 1, and the read address counter 3 generates a read address signal for reading out the video signal S3 serving as an output video from the memory 1. Besides, the both address counters 2 and 3 perform counting from their normal address start positions in their stationary states, and both make the frame memory area as an address range serving as a target for writing or reading of the memory.

The synchronization separation circuit 4 separates a vertical synchronization signal and a horizontal synchronization signal from the input video signal S1.

The address comparison circuit 5 compares the write address signal and the read address signal, and thereby observes the difference in address between the write address signal and the read address signal.

The judgment circuit 6 judges the comparison result of the address comparison circuit 5 at timings of the vertical synchronization signal, and outputs a flag signal S5 when it detects a state where either of the write and read address signals almost overtakes the other address signal.

The address control circuit 7 controls the write address counter 2 and the read address counter 3 on the basis of the flag signal S5 indicating the judgment result of the judgment circuit 6. That is, a state where no flag signal S5 is outputted is supposed as a stationary state, and the frame memory area is set as an address range serving as a target for writing or reading. On the other hand, a state where a flag signal S5 is outputted is made as a judgment range state, and the address range serving as a target for writing or reading is extended to include not only the frame memory area but also up to the buffer area, thereby the entire region in the memory 1 is employed as the address range as a target for writing or reading.

Hereinafter, the operation of the conventional frame synchronizer circuit will be described.

The input video signal S1 is written into the memory 1 by a write address signal that is generated by the write address counter 2 on the basis of the write clock S2. On the other hand, the output video signal S3 is read from the memory 1 by a read address signal that is generated by the read address counter 3 on the basis of the read clock S4. Thereby, the input video signal S1 synchronized with the write clock S2 is converted into the output video signal S3 synchronized with the read clock S4.

The address difference between the write address signal and the read address signal is observed by the address comparison circuit 5, and when either of the address signals almost overtakes the other address signal, the judgment circuit 6 outputs a flag signal S5 to the address control circuit 7 at timings of the vertical synchronization signal of the input video signal S1.

The use area of the memory 1 which is controlled by the write address counter 2 and the read address counter 3 which are controlled by the address control circuit 7 will be described with reference to FIGS. 7(a) and 7(b). Herein, the writing or reading processing of video signal to the memory 1 is carried out for each frame of the video data.

In the stationary state, as shown in FIG. 7(a), the write address counter 2 writes in a head line of the video into the head position of the memory 1, i.e., an address start position, and writes in a final line of the video into the end position of the one frame memory area. The write address counter 2 writes in a head line of a next frame again into the head position of the memory 1. On the other hand, the read address counter 3 reads out the head line of video from the head position of the memory 1, and reads out the final line from the end position of the frame memory area. The read address counter 2 reads out the head line of the next frame again from the head position of the memory 1. Thus, in the stationary state, only the frame memory area in the memory 1 is used, while the buffer area is not used.

On the other hand, in the judgment range state, the address range is extended to include up to the buffer area, and thereby data writing or reading is performed for the all addresses in the memory 1, and the buffer area is shifted frame by frame as shown in FIG. 7(b).

In FIG. 7(b), assuming that (N−1)th frame indicates a final frame in the stationary state and it enters the judgment range state at next N-th frame, the head line of N-th frame is written into a position next to the end position in the frame memory area of (N−1)th frame, i.e., a head position in the buffer area. When the writing into the buffer area is completed, the writing of following data is performed from the head position in the memory 1, with a memory pointer returning to that position. When the writing for one frame is completed, the buffer area is shifted to behind the final line of the video of (N−1)th frame. The head line of next (N+1)th frame is written in into the head position in the buffer area for N-th frame, and when the writing up to the final line of the memory 1 is completed, the writing of following data is performed from the head position in the memory 1. When the writing for one frame is completed, the buffer area is shifted to behind the final line of the video of (N+1)th frame.

In this way, in the judgment range state, the writing operation uses the memory 1 as a ring buffer. The reading operation also uses the memory 1 as a ring buffer, and reads the data continuously from the whole address region in the memory 1 including the buffer area.

FIGS. 8(a)-8(d) show the specific operations of the write address signal, the read address signal, and the flag signal. FIG. 8(a) shows the relationship between the phases of the write address and read address signal and time when the write address signal overtakes the read address signal. In FIG. 8(a), a solid line shows the write address signal, and a dotted line shows the read address signal. FIG. 8(b) shows a flag signal, FIG. 8(c) shows frame numbers of the video signal which are controlled by the write address signal, and FIG. 8(d) shows frame numbers of the video signal which are controlled by the read address signal.

With reference to FIG. 8, the write address signal almost overtakes the read address number when the write frame number is 3. This write frame number 3 is the final frame in the stationary state.

A flag signal S5 is outputted when the write frame number is 4, and then it enters the judgment range state. In the judgment range state, the memory 1 is used as a ring buffer by performing writing in into the buffer area. Then, since the read frame number 3 still indicates the stationary state operation, the write address signal and the read address signal are once separated from each other by an amount corresponding to the buffer area. Thereafter, while the flag signal is being outputted, the start position of the write address signal is shifted frame by frame. Further, the reading operation is also performed, in order to continuously read the normal signals from the memory, with shifting the start position of the read address signal frame by frame as in the above-mentioned writing operation.

Then, the write address signal again almost takes over the read address signal when the write frame number is 6. No flag signal is outputted when the write frame number is 7, and it returns to the stationary state. In the writing operation then, the head line of the frame is written in into the head position of the memory 1. Further, the reading operation returns to the stationary state at the timing when the read frame number 5 is read. The read frame number read then is 7. That is, skipping occurs, which skips reading the frame number 6. In this way, occurrence of a frame including new and old frames mixed in one frame is avoided, and thereby a temporarily continuous output video signal S3 is outputted.

Patent Document 1: Japanese Published Patent Application No.

In the conventional frame synchronizer circuit, however, it is supposed that a difference in frame frequency between the input video signal S1 and the output video signal S3 should be smaller than the buffer capacity that is secured in the memory 1. Further, in the conventional frame synchronizer circuit, control for the write address signal and for the read address signal must be kept normal when the operation is in the judgment range state.

Since a difference in frame frequency between the input video signal S1 and the output video signal S3 is very small when the input video signal S is a standard signal based on the standard specification, a buffer area may sufficiently comprise several lines. However, when the input video signal S1 includes a nonstandard signal such as fast-forward playback in VTR, if the frame frequency difference between the input video signal S1 and the output video signal S3 is 50 lines, a flag signal cannot be correctly outputted unless the buffer capacity is increased, leading to a problem that the output video signal is not normally outputted.

Now, the operation in the case where the frame frequency difference is larger than the buffer capacity will be described with reference to FIGS. 9(a)-9(d). FIG. 9(a) shows the relationships between the phases of the write address and read address signal and time. FIG. 9(b) shows the flag signal, FIG. 9(c) shows frame numbers of the video signal which are controlled by the write address signal, and FIG. 9(d) shows frame numbers of the video signal which are controlled by the read address signal.

The write address signal almost overtakes the read address signal when the write frame number is 3, and a flag signal is outputted at the write frame number 4 to start writing into the buffer area. At this time, the read address signal reads the read frame number 3. However, since the frame frequency difference is large, the write address signal overtakes the read address signal while the frame number 3 is read, resulting in a phenomenon that the read frame number 4 is outputted while the read frame number 3 is being outputted. When such phenomenon occurs, old and new frames, i.e., the frames of the read frame number 3 and the read frame number 4, are mixed as shown in FIG. 9(d), whereby discontinuity of video undesirably occurs in the case of a moving picture. However, in the case of a still picture, no discontinuity of video practically occurs because the old and new frames are the same video. Further, when fast-forward playback in VTR is performed, since several noise bars have already been inserted in the output video, discontinuity of video is practically unnoticeable even in the case of a moving picture.

However, when a still picture as shown in FIG. 10(a) is inputted to the conventional frame synchronizer circuit, since the memory 1 is used as a ring buffer while a flag signal is outputted, old and new frames are mixed in the output video signal, and further, a picture corresponding to the read frame number 4 is shifted upward by an amount of the buffer area as shown in FIG. 10(b). Thus, in the conventional frame synchronizer circuit, an abnormal video signal is outputted irregardless of whether the video signal is a moving picture or a still picture, while the flag signal is outputted.

### SUMMARY OF THE INVENTION

The present invention is made to solving the above-described problems and has for its object to provide a frame synchronizer circuit which can minimize the buffer region in the memory, and can appropriately control the address range of the memory as a target for writing or reading even when the frame frequency difference exceeds the buffer capacity and thereby can prevent occurrence of distortions in the output image.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, there is provided a frame synchronizer circuit which performs a frame frequency conversion by writing an input video signal including a nonstandard signal into a memory according to a write address signal as needed and reading out video signal from the memory according to a read address signal as needed, and the circuit comprises a flag means for comparing the write address signal and the read address signal and generating a flag when having detected a state where either of the write and read address signal almost overtakes the other address signal, a difference calculation means for calculating the difference in frame frequency difference between the write address signal and the read address signal and halting generating the flag when the difference is equal to or larger than a predetermined value, and an address control means for setting an address range serving as a target for writing or reading of the memory according to the presence or absence of the generated flag.

Therefore, it is possible to avoid occurrence of distortions in the output video even when the output video includes old and new frames mixed.

According to a second aspect of the present invention, in the frame synchronizer circuit according to the first aspect, the memory includes a buffer area which is smaller than a supposed signal quantity corresponding to the frame frequency difference between the input video signal and the output video signal, the difference calculation means is operated to halt generating the flag when the frame frequency difference is larger than the capacity of the buffer area, and the address control means employs one frame memory area for an address range serving as a target for writing or reading of the memory when the flag is not generated, while makes the buffer area be included in the address range serving as a target for writing or reading of the memory when the flag is generated.

Therefore, it is possible to minimize the buffer area, and also possible to appropriately control the writing operation and the reading operation even when the frame frequency difference between the both address signals exceeds the buffer quantity, thereby preventing the output video from being displayed as discontinuous pictures.

According to a third aspect of the present invention, there is provided a frame synchronizer circuit which performs a frame frequency conversion by writing an input video signal including a nonstandard signal into a memory according to a write address signal as needed and reading out video signal from the memory according to a read address signal as needed, and the circuit comprises a first flag means for comparing the write address signal and the read address signal and generating a first flag when having detected a state where either of the write and read address signals almost overtakes the other address signal, a second flag means for generating a second flag when the both address signals coincide with each other, and an address control means for setting an address range serving as a target for writing or reading of the memory according to presence or absence of the generated flag, while reducing the address value of the write address signal by a predetermined address value when both the first and second flags are generated.

Therefore, it is possible to avoid occurrence of overtaking of the address signal, which also avoids the mixing of new and old frames in the address signal, thereby preventing distortion in the output video.

According to a fourth aspect of the present invention, in the frame synchronizer circuit according to the third aspect, the memory includes a buffer area which is smaller than a supposed signal quantity corresponding to the frame frequency difference between the input video signal and the output video signal, and the address control means employs one frame memory area for an address range serving as a target for writing or reading of the memory when the first flag is not generated, and makes the buffer area be included in the address range serving as a target for writing or reading of the memory when the first flag is generated.

Therefore, it is possible to minimize the buffer area, and also possible to appropriately control the writing operation and the reading operation even when the frame frequency difference between the both address signals exceeds the buffer quantity, thereby preventing the output video from being displayed as discontinuous pictures.

According to a fifth aspect of the present invention, in the frame synchronizer circuit according to the fourth aspect, the address control means reduces the address value of the write address signal by an amount corresponding to the buffer area when both the first and second flags are generated.

Therefore, it is possible to avoid that either of the write and read address signals overtakes the other address signal, and thereby it is possible to output the video signal which does not include new and old frames mixed.

According to a sixth aspect of the present invention, there is provided a frame synchronizer circuit which performs a frame frequency conversion by writing an input video signal including a nonstandard signal into a memory according to a write address signal as needed and reading out video signal from the memory according to a read address signal as needed, and the circuit comprises a first flag means for comparing the write address signal and the read address signal and generating a first flag when detecting a state where either of the address signals almost overtakes the other address signal, a second flag means for generating a second flag when the both address signals coincide with each other, and an address control means for setting an address range serving as a target for writing or reading of the memory according to presence or absence of the generated flag, while holding the address value of the write address signal for a predetermined period of time when both the first and second flags are generated.

Therefore, it is possible to avoid occurrence of overtaking of the address signal, which also avoids the mixing of new and old frames in the address signal, thereby preventing distortion in the output video.

According to a seventh aspect of the present invention, in the frame synchronizer circuit according to the sixth aspect, the memory includes a buffer area which is smaller than a supposed signal quantity corresponding to the frame frequency difference between the input video signal and the output video signal, and the address control means employs one frame memory area for an address range serving as a target for writing or reading of the memory when the first flag is not generated, while makes the buffer area be included in the address range serving as a target for writing or reading of the memory when the first flag is generated.

Therefore, it is possible to minimize the buffer area, and also possible to appropriately control the writing operation and the reading operation even when the frame frequency difference between the both address signals exceeds the buffer quantity, thereby preventing the output video from being displayed as discontinuous pictures.

According to an eighth aspect of the present invention, in the frame synchronizer circuit according to the sixth aspect, the address control means holds the address value of the write address signal up until the writing for one frame is completed when both the first and second flags are generated.

Therefore, it is possible to avoid that either of the write and read address signals overtakes the other address signal, and thereby it is possible to output the video signal which does not include new and old frames mixed.

According to a ninth aspect of the present invention, in the frame synchronizer circuit according to the sixth aspect, the memory is a unified memory, and the writing into a predetermined memory area of the memory is halted when the second flag is generated.

Therefore, it is possible to enhance the system performance by suppressing the bandwidth as well as to reduce the power consumption.

### EFFECTS OF THE INVENTION

According to the frame synchronizer circuit according to the present invention, since it is provided with means for calculating the difference in frame frequency between the input video signal and the output video signal and when the frame frequency difference is larger than the buffer capacity, the frame synchronizer circuit performs such a control that prevents either of the write and read address signal from overtaking the other address signal, i.e., such a control that a memory area for one frame is set as an address range serving as a target for writing or reading of a memory, it is prevented that the output video image is shifted upward, without the output video signal including new and old frames mixed.

According to the frame synchronizer circuit of the present invention, since when the both address signals have become equal to each other while either of the write and read address signal almost overtakes the other address signal, the address value of the write address signal is reduced by an amount corresponding to the buffer capacity, the video signal is outputted, without the outputted video signal including new and old frames mixed.

According to the frame synchronizer circuit of the present invention, since when the both address signals have become equal to each other while either of the write and read address signal almost overtakes the other address signal, the address value of the write address signal is held thereby to halt the writing of data into the memory, and thus the video signal is outputted, without the output video signal including new and old frames mixed, as well as the bandwidth for the output video is suppressed and thereby an enhanced system performance is resulted.

### BRIEF DESCRIPTION OF THE DRAWINGS

FIG. 1 is a block diagram illustrating a schematic configuration of a frame synchronizer circuit according to a first embodiment of the present invention.

FIG. 2 is a diagram for explaining the operation of the frame synchronizer circuit according to the first embodiment.

FIG. 3 is a block diagram illustrating a schematic configuration of a frame synchronizer circuit according to a second embodiment of the present invention.

FIG. 4 is a diagram for explaining the operation of the frame synchronizer circuit according to the second embodiment.

FIG. 5 is a diagram for explaining the operation of a frame synchronizer circuit according to a third embodiment of the present invention.

FIG. 6 is a block diagram illustrating the conventional frame synchronizer circuit.

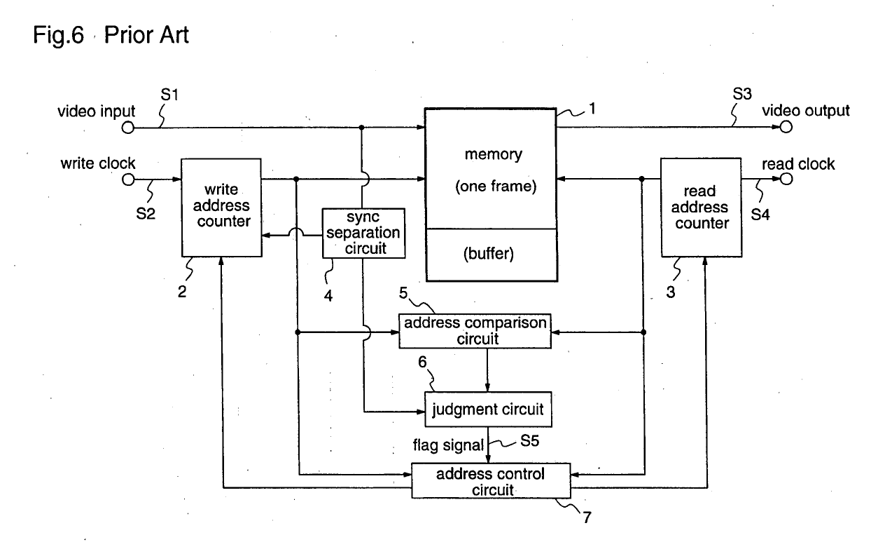

FIG. 7 is a diagram for explaining a usage area of a memory in the conventional frame synchronizer circuit.

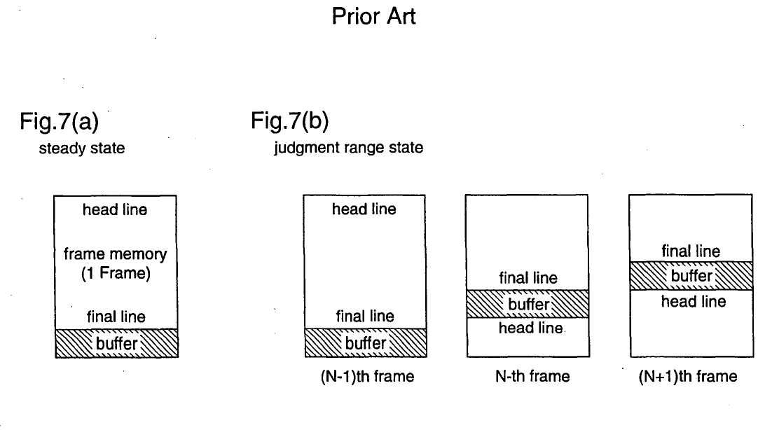

FIG. 8 is a diagram for explaining the relationship between a write address signal and a read address signal, and a flag signal in the conventional frame synchronizer circuit.

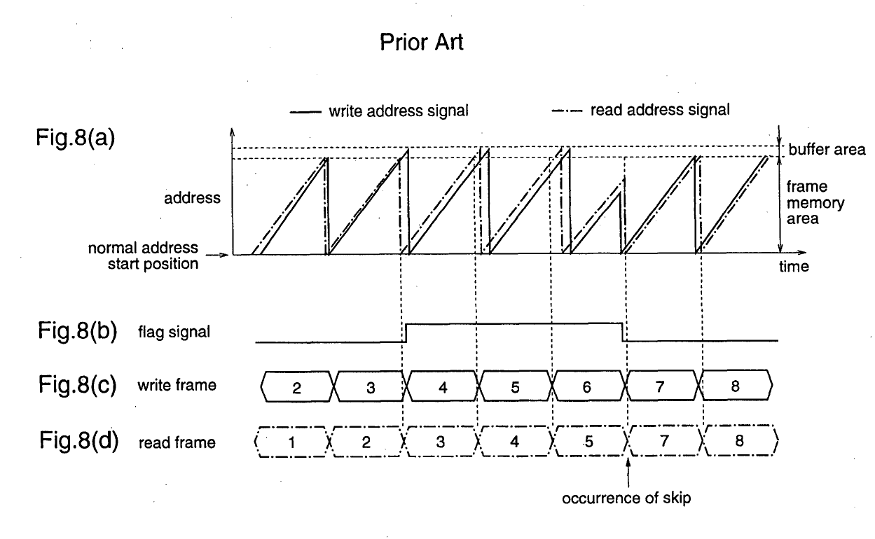

FIG. 9 is a diagram illustrating the operation of the conventional frame synchronizer circuit when a frame frequency difference is larger than a buffer capacity.

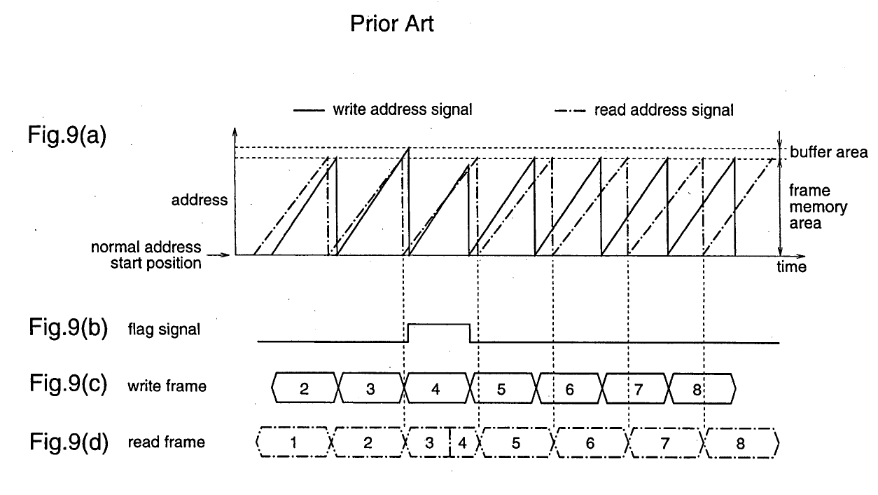

FIG. 10 is a diagram illustrating an output video signal when a still picture is input to the conventional frame synchronizer circuit.

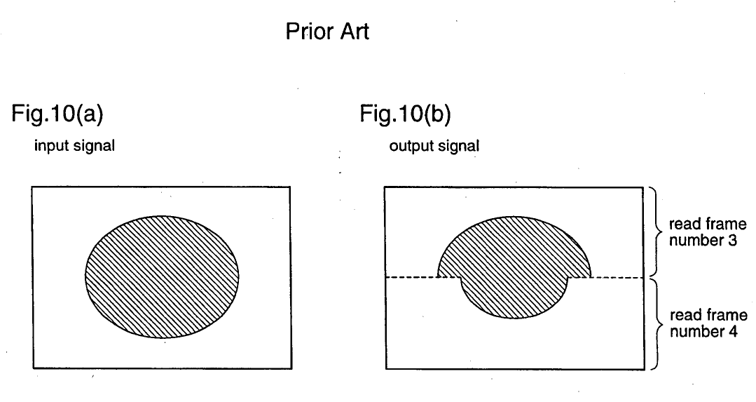

### DETAILED DESCRIPTION OF THE PREFERRED EMBODIMENTS

Hereinafter, embodiments of the present invention will be described with reference to the drawings.

### First Embodiment

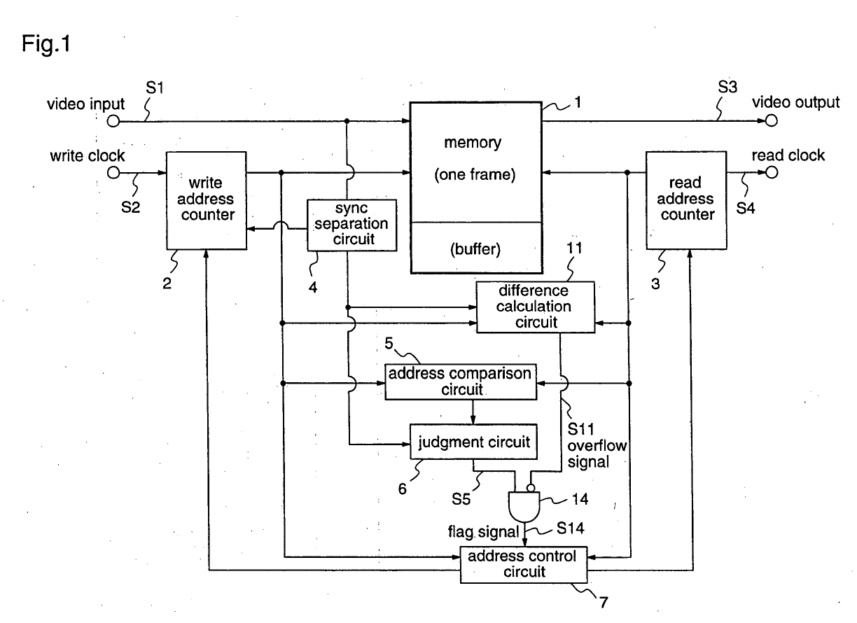

Hereinafter, a frame synchronizer circuit according to a first embodiment of the present invention will be described with reference to FIG. 1. FIG. 1 is a block diagram illustrating a construction of the frame synchronizer circuit according to the first embodiment.

The frame synchronizer circuit shown in FIG. 1 includes a memory 1, a write address counter 2, a read address counter 3, a synchronization separation circuit 4, an address comparison circuit 5, a judgment circuit 6, an address control circuit 7, a difference calculation circuit 11, and a gate circuit 14.

The memory 1 has a memory area for one frame (frame memory area) and a buffer area having a predetermined capacity. The buffer area is smaller than a supposed signal quantity corresponding to the difference in frame frequency between the input video signal S1 and the output video signal S3.

The write address counter 2 generates a write address signal for writing the input video signal S1 into the memory 1, and the read address counter 3 generates a read address signal for reading the output video signal S3 from the memory 1. Besides, the both address counters 2 and 3 perform counting from a normal address start position in their stationary states and make the frame memory area serving as an address range as target for writing or reading of the memory.

The synchronization separation circuit 4 separates a vertical synchronization signal and a horizontal synchronization signal from the input video signal S1.

The address comparison circuit 5 compares the write address signal and the read address signal, and thereby observes the difference in address between the write address signal and the read address signal.

The judgment circuit 6 judges the comparison result of the address comparison circuit 5 at timings of the vertical synchronization signal, and outputs a flag signal S5 when it detects a state where either of the write and read address signals almost overtakes the other address signal.

The difference calculation circuit 11 calculates a frame frequency difference by observing an operation amount of the write address signal that is outputted from the write address counter 2, while the read address signal that is outputted from the read address counter 3 performs one frame operation. When the calculated frame frequency difference exceeds a predetermined capacity (buffer capacity), the difference calculation circuit 11 outputs an overflow signal S11.

The gate circuit 14 determines whether the flag signal S5 that is outputted from the judgment circuit 6 is to be outputted to the address control circuit 7 or not, on the basis of the frame frequency difference calculated by the difference calculation circuit 11. That is, the gate circuit 14 generates a flag signal S14 according to the flag signal S5 that is outputted from the judgment circuit 6 when no overflow signal S11 is outputted, while it gates the flag signal S5 that is outputted from the judgment circuit 6 to halt to generate the flag signal S14 while an overflow signal S11 is outputted.

The address control circuit 7 controls the write address counter 2 and the read address counter 3 on the basis of presence or absence of generated flag signal S14 in the gate circuit 14. That is, the state where no flag signal is outputted is supposed as a stationary state, and the frame memory area is set as an address range serving as a target for writing or reading. On the other hand, the state where the flag signal S14 is outputted is made as a judgment range state, and in this judgment range state, the address region serving as a target for writing or reading is extended to include not only the frame memory region but also up to the buffer region, thereby the entire region in the memory 1 is employed as the address region as a target for writing or reading.

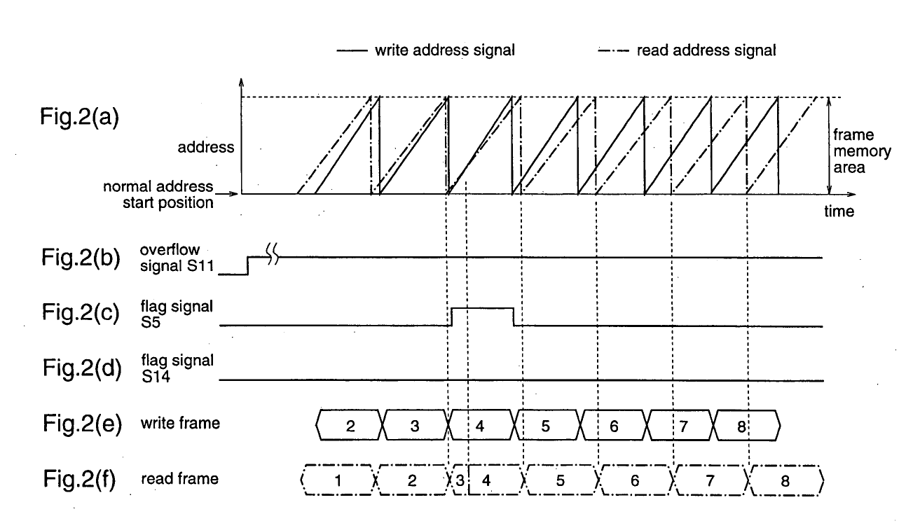

Next, the writing operation and reading operation by the frame synchronizer circuit according to the first embodiment will be described with reference to FIGS. 2(a)-2(f).

FIG. 2(a) shows the relationship between the write address signal and the read address signal, and time. FIG. 2(b) shows the overflow signal S11, FIG. 2(c) shows the flag signal S5, FIG. 2(d) shows the flag signal S14, FIG. 2(e) shows frame numbers of the video signal which are controlled by the write address signal, and FIG. 2(f) shows frame numbers of the video signal which are controlled by the read address signal.

Herein, a description is given of a case where the frame frequency difference between the input video signal S1 and the output video signal S3 has exceeded the buffer capacity. Then, the difference calculation circuit 11 outputs an overflow signal S11 indicating that the frame frequency difference has exceeded the buffer capacity as shown in FIG. 2(b).

The write address signal almost overtakes the read address signal when the write frame number is 4 as shown in FIG. 2(a), and then, a flag signal S5 is generated by the judgment circuit 6 as shown in FIG. 2(c). However, this flag signal S5 cannot pass the gate by the overflow signal S11 that is outputted from the difference calculation circuit 11, and a flag signal S14 that is to be input to the address control circuit 7 is not generated as shown in FIG. 2(d), thereby the write frame number 4 cannot enter the judgment range state. Accordingly, the head line of the frame is again written in into the head position in the memory 1. Herein, since in this case the frame frequency difference is larger than the buffer capacity, the write address signal would overtake the read address signal in the way of the read frame number 3 being read as shown in FIG. 2(a), and thereby the read frame number 4 would be outputted in the way of the read frame number 3 being read as shown in FIG. 2(f). In this first embodiment, however, since the use state of the memory 1 is controlled to be in the stationary state, the memory 1 would not used as a ring buffer, and images of the new and old frames would be written in into the same position in the memory. Thereby, in a case of still picture, undesirable phenomenon such as occurrence of discontinuity in video or upward or downward shifting of video by an amount corresponding to the buffer area would not practically occur, and normal video can be outputted even when the output video includes new and old frames mixed. Further, when performing a fast-forward playback or a reverse playback in VTR, noise bars are already generated in the output image, thereby arising no noticeable discontinuity in the output video even when the output video includes mixed new and old frames.

According to the frame synchronizer circuit of this first embodiment, when the frame frequency difference between the input video signal and the output video signal is larger than the buffer capacity, the flag signal S5 that is outputted from the judgment circuit 6 is prevented to pass the gate so as to prevent from entering the judgment range state. This can prevent the output video from shifting upward or downward even when the output video includes mixed old and new frames. Further, the buffer area is suppressed to necessary minimum, and the writing and reading operation are appropriately controlled even when the frame frequency difference exceeds the buffer area, and thereby the output video is prevented from being displayed as discontinuous pictures.

### Second Embodiment

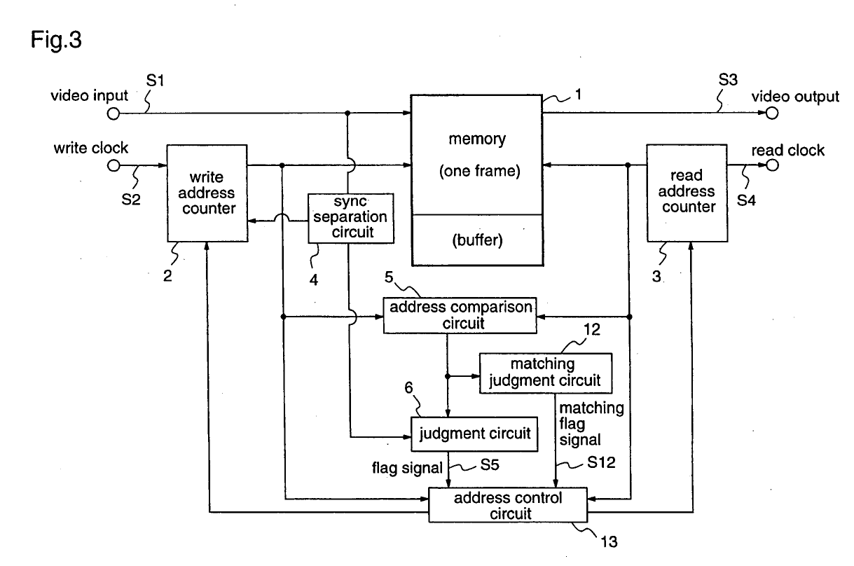

Hereinafter, a frame synchronizer circuit according to a second embodiment of the present invention will be described with reference to FIG. 3. FIG. 3 is a block diagram illustrating a construction of the frame synchronizer circuit according to the second embodiment.

The frame synchronizer circuit of this second embodiment includes a memory 1, a write address counter 2, a read address counter 3, a synchronization separation circuit 4, an address comparison circuit 5, a judgment circuit 6, a matching judgment circuit 12, and an address control circuit 13. In FIG. 3, the same reference numerals as those shown in FIG. 1 denote the same elements, and therefore, repeated description is not necessary.

The matching judgment circuit 12 judges whether the write address signal and the read address signal match or not, and outputs a matching flag signal S12 indicating the judgment result.

The address control circuit 13 controls the write address counter 2 and the read address counter 3 on the basis of the flag signal S5 and the matching flag signal S12. That is, a state where no flag signal S5 is outputted is regarded as a stationary state, and the frame memory area is set as an address region to be subjected to writing/reading. Further, a state where a flag signal S5 is being outputted is regarded as a judgment range state, and the whole area in the memory 1 including not only the frame memory area but also the buffer area is set as an address region to be subjected to writing/reading.

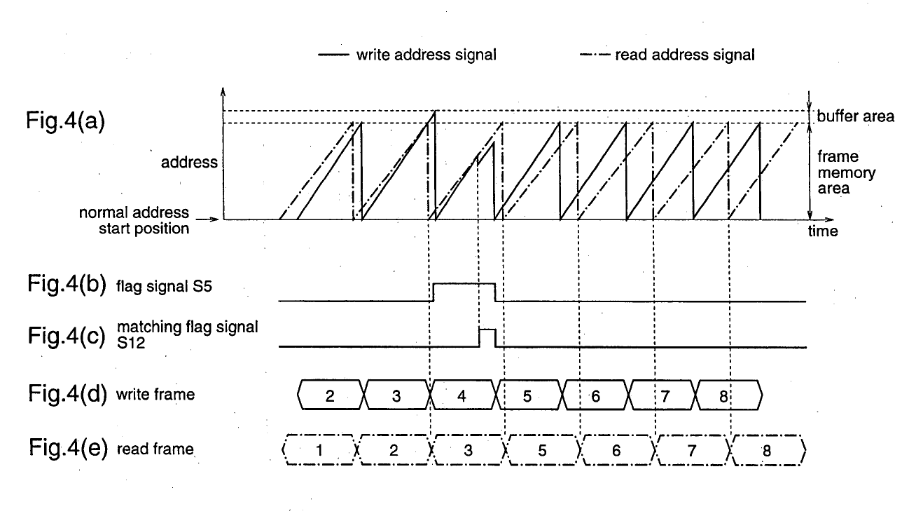

Next, the operation of the frame synchronizer circuit according to the second embodiment will be described with reference to FIGS. 4(a)-4(e).

FIG. 4(a) shows the relationship between the write address signal and the read address signal, and time. FIG. 4(b) shows the flag signal S5, FIG. 4(c) shows the matching flag signal S12, FIG. 4(d) shows frame numbers of the video signal which are controlled by the write address signal, and FIG. 4(e) shows frame numbers of the video signal which are controlled by the read address signal.

The write address signal almost overtakes the read address signal when the write frame number is 4 as shown in FIG. 4(a), and the judgment circuit 6 generates a flag signal S5 as shown in FIG. 4(b). Further, since the frame frequency difference is larger than the buffer capacity, the write address signal would overtake the read address signal in the way of the read frame number 3 being read. However, in this second embodiment, when the both address signals coincide with each other, the matching judgment circuit 12 outputs a matching flag signal S12 as shown in FIG. 4(c). Then, the write address counter 2 carries out a processing of returning the address value back by an amount corresponding to the buffer capacity, and thereby it is avoided that the write address signal should overtake the read address signal, as shown in FIG. 4(a). Thereby, it is avoided that the read frame number 3 is overwritten onto the write frame number 4 from the way of the write frame number 4, as shown in FIGS. 4(d) and 4(e). Further, the frame next to the read frame number 3 has a read frame number 5, thereby occurring no mixing of new and old frames.

According to the frame synchronizer circuit of this second embodiment, there is provided a matching judgment circuit 12 for detecting that the write address signal and the read address signal coincide with each other, and when the both address signals coincide with each other during being in the judgment range state, the address value of the write address signal is reduced by an amount corresponding to the buffer capacity. Thereby, it is avoided that either of the address signals overtake the other address signal. Thus, new and old frames are not mixed in the output video signal in the judgment range state, and thereby it is prevented from occurring distortions in the output video.

### Third Embodiment

A frame synchronizer circuit according to a third embodiment of the present invention is constructed to hold a write address counter value when a matching flag signal according to the second embodiment is outputted.

The construction of the frame synchronizer circuit according to the third embodiment is identical to that of the second embodiment shown in FIG. 3, a further description is omitted.

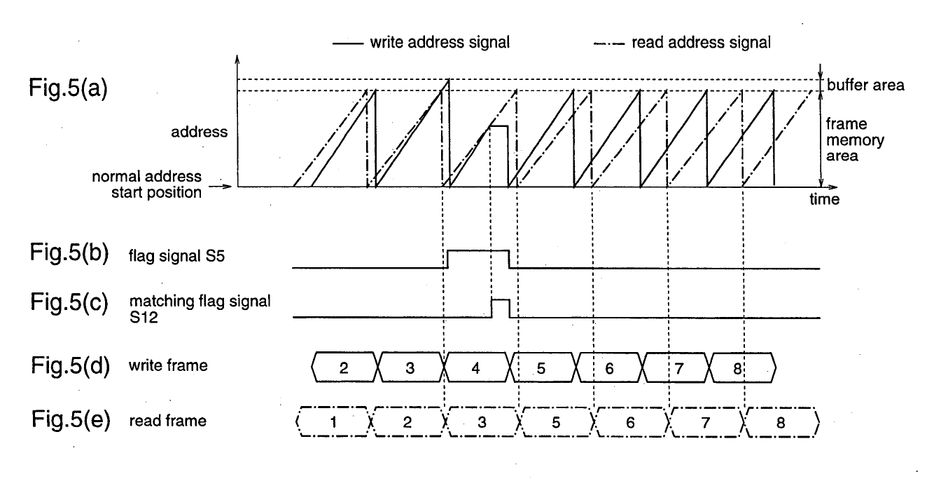

Next, the operation of the frame synchronizer circuit according to the third embodiment will be described with reference to FIGS. 5(a)-5(e).

FIG. 5(a) shows the relationship between the write address and read address signal and time. FIG. 5(b) shows the flag signal S5, FIG. 5(c) shows the matching flag signal S12, FIG. 5(d) shows frame numbers of the video signal which are controlled by the write address signal, and FIG. 5(e) shows frame numbers of the video signal which are controlled by the read address signal.

The write address signal almost overtakes the read address signal when the write frame number is 4 as shown in FIG. 5(a), and the judgment circuit 6 generates a flag signal S5 as shown in FIG. 5(b). Further, since the frame frequency difference is larger than the buffer capacity, the write address signal would overtake the read address signal in the way of the read frame number 3 being read. However, in this third embodiment, when the both address signals coincide with each other, the matching judgement circuit 12 outputs a matching flag signal S12 as shown in FIG. 5(c). Then, the write address value is held for a predetermined period of time, i.e., during a period until writing for one frame is completed, and thereby it is avoided that the write address signal should overtake the read address signal, as shown in FIG. 5(a). Thereby, it is avoided that the read frame number 3 is overwritten onto the write frame number 4 from the way of the write frame number 4, as shown in FIGS. 5(d) and 5(e). Further, the frame next to the read frame number 3 has a read frame number 5, thereby occurring no mixing of new and old frames. Further, with relative to the second embodiment, there is no necessity of providing a circuit for returning back the counter value of the write address counter 2.

When the memory 1 is a unified memory, plural function circuits perform system operations with their reading and writing operations into the memory 1 being adjusted. In recent years, bandwidth restrictions on memories have been more strict while a lot of function circuits are used, and reduction in the bandwidth by reduction of unnecessary writing and reading leads to an enhanced system performance. Therefore, when the matching flag signal S12 is outputted, the writing of the input video signal S1 into the memory 1 may be halted. In this case, the read frame number 3 is not overwritten onto the write frame number 4 in the way of the write frame number 4, and the frame next to the read frame number 3 has a read frame number 5, thereby mixing of new and old frames is avoided. Further, when the bandwidth is reduced by avoiding writing of excessive video signals into the memory 1, the bandwidths for other functions can be increased, thereby the system performance is enhanced and the power consumption is reduced.

According to the frame synchronizer circuit of this third embodiment, there is provided a matching judgment circuit 12 for detecting that the write address signal and the read address signal coincide with each other, and when the both address signals coincide with each other during in the judgment range state, the address value of the write address signal is held for a predetermined period of time to halt writing into the memory 1. Thereby, it is avoided that either of the address signals overtake the other signal. Thus, new and old frames are not mixed in the output video signal in the judgment range state, and thereby it is prevented from occurring distortions in the output video.

### APPLICABILITY IN INDUSTRY

A frame synchronizer circuit according to the present invention is useful as a circuit that can be constituted by less buffer capacity even when a nonstandard signal is inputted.

What is claimed is:

1. A frame synchronizer circuit which performs a frame frequency conversion by writing an input video signal including a nonstandard signal into a memory according to a write address signal as needed and reading out video signal from the memory according to a read address signal as needed, said circuit comprising:
a flag means for comparing the write address signal and the read address signal and generating a flag when having detected a state where either of the write and read address signal almost overtakes the other address signal;
a difference calculation means for calculating the difference in frame frequency difference between the write address signal and the read address signal and halting generating the flag when the difference is equal to or larger than a predetermined value; and
an address control means for setting an address range serving as a target for writing or reading of the memory according to the presence or absence of the generated flag.

2. A frame synchronizer circuit as defined in claim 1 wherein
said memory includes a buffer area which is smaller than a supposed signal quantity corresponding to the frame frequency difference between the input video signal and the output video signal,
said difference calculation means is operated to halt generating the flag when the frame frequency difference is larger than the capacity of the buffer area, and
said address control means employs one frame memory area for an address range serving as a target for writing or reading of the memory when the flag is not generated, while makes the buffer area be included in the address range serving as a target for writing or reading of the memory when the flag is generated.

3. A frame synchronizer circuit which performs a frame frequency conversion by writing an input video signal including a nonstandard signal into a memory according to a write address signal as needed and reading out video signal from the memory according to a read address signal as needed, said circuit comprising:
a first flag means for comparing the write address signal and the read address signal and generating a first flag when having detected a state where either of the write and read address signals almost overtakes the other address signal;
a second flag means for generating a second flag when the both address signals coincide with each other; and
an address control means for setting an address range serving as a target for writing or reading of the memory according to presence or absence of the generated flag, while reducing the address value of the write address signal by a predetermined address value when both the first and second flags are generated.

4. A frame synchronizer circuit as defined in claim 3 wherein
said memory includes a buffer area which is smaller than a supposed signal quantity corresponding to the frame frequency difference between the input video signal and the output video signal, and
said address control means employs one frame memory area for an address range serving as a target for writing or reading of the memory when the first flag is not generated, and makes the buffer area be included in the address range serving as a target for writing or reading of the memory when the first flag is generated.

5. A frame synchronizer circuit as defined in claim 4 wherein said address control means reduces the address value of the write address signal by an amount corresponding to the buffer area when both the first and second flags are generated.

6. A frame synchronizer circuit which performs a frame frequency conversion by writing an input video signal including a nonstandard signal into a memory according to a write address signal as needed and reading out video signal from the memory according to a read address signal as needed, said circuit comprising:
a first flag means for comparing the write address signal and the read address signal and generating a first flag when detecting a state where either of the address signals almost overtakes the other address signal;
a second flag means for generating a second flag when the both address signals coincide with each other; and
an address control means for setting an address range serving as a target for writing or reading of the memory according to presence or absence of the generated flag, while holding the address value of the write address signal for a predetermined period of time when both the first and second flags are generated.

7. A frame synchronizer circuit as defined in claim 6 wherein
said memory includes a buffer area which is smaller than a supposed signal quantity corresponding to the frame frequency difference between the input video signal and the output video signal, and
said address control means employs one frame memory area for an address range serving as a target for writing or reading of the memory when the first flag is not generated, while makes the buffer area be included in the address range serving as a target for writing or reading of the memory when the first flag is generated.

8. A frame synchronizer circuit as defined in claim 6 wherein, said address control means holds the address value of the write address signal up until the writing for one frame is completed when both the first and second flags are generated.

9. A frame synchronizer circuit as defined in claim 6 wherein said memory is a unified memory, and the writing into a predetermined memory area of the memory is halted when the second flag is generated.
